(19) United States
(12) Patent Application Publication
(10) Pub. No.: US 2018/0174200 A1
(43) Pub. Date: Jun. 21, 2018

(54) SYSTEM AND METHOD FOR LEASING AND PROJECTING A GEOGRAPHICAL VIEW

(71) Applicants: David Kean Peyman, Richmond, VA (US); Nazmi Peyman, Richmond, VA (US)

(72) Inventors: David Kean Peyman, Richmond, VA (US); Nazmi Peyman, Richmond, VA (US)

(21) Appl. No.: 15/721,947

(22) Filed: Oct. 1, 2017

(51) Int. Cl. G06Q 30/02

(52) U.S. Cl. CPC G06Q 30/0273; G06Q 30/0241

(57) ABSTRACT

A system and method for leasing and projecting a geographical view on a window via a single platform are disclosed. The system comprises a webserver in communication with a database. The system is configured to receive advertiser information and lessee information and configured to store the received information in the database. The system is further configured to advertise a data comprising at least one geographical view for leasing at a monetary value, wherein the data is stored in the database. The system further configured to specify criteria to identify at least one desired geographical view by the lessee. The system is further configured to search for the at least one desired geographical view matching the criteria specified by the lessee. The system further configured to display at least one leased geographical view from the webserver on the at least one window.

### BACKGROUND OF THE INVENTION

### A. Technical Field

The present invention generally relates to system and method for broadcasting a geographical view. More specifically, this invention relates to a system and method for leasing and projecting a geographical view on a window via a single platform.

### B. Description of Related Art

With an advancement of today's technology in high speed internet, high definition TVs, sound recording and broadcasting systems and cameras, it is possible to record and broadcast a geographical view from a popular location to any remote part of the world. Such geographical view displayed on a premise may attract more people at the displayed vicinity. For example, disposing a billboard projecting a display content at the shopping mall might attract more customers, and at the same time profits the shopping mall by attracting customers. However, to display the geographical view on a display window user needs physical visit to conventional shops. webservice offers to acquire geographical view from their place of residence, however, the user need to do intensive search in online by opening every website displayed in the browser.

Further, the geographical view projected at a premise should be continuously updated or changed to keep up with the interest of the people, hence buying the geographical view for full cost to utilize it for a fleeting period is not beneficial to the buyer. Further many people have a hobby of visiting remote locations and capturing the geographical view. Finding buyers to monetize their geographical view form their place of residence is also not possible. Conventional system only allows user to share a geographical view, more particularly, a user may capture a geographical view in their mobile device and may post in social network. However, conventional system does not allow a user to monetize their acquired geographical view from their place of residence to one or multiple users across various location.

Therefore, there is a need for a system and method that allows to match a user willingness to share a geographical view at a monetary value from their place of residence. Further, there is a need for a system that projects the acquired geographical view at a display window at a remote or closer location. Further, there is a need for a system that allows a user to lessee a desired geographical view for a predetermined period. Further, a system is required to transmit a real-time recorded view to the desired users to enable the users to experience or mimic a living of a desired geographical location at a window of one's own residence or building or office on an affordable cost through a single platform.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The present invention generally relates to a system and method for broadcasting a geographical view. Specifically, this invention relates to a system and method for leasing and projecting a geographical view on a window via a single platform. The system comprises a webserver in communication with a database. The webserver includes a processor and a memory unit comprising a set of program modules. The set of program module comprises an advertiser registration module, a lessee registration module, an advertising module, a request generation module, a search engine module, a leasing module, a display module, and a tracking module. The processor in communication with the memory unit and the database is configured to execute the set of program modules. In one embodiment, a computing device associated with a user is enabled to access the webserver via a network. In one embodiment, the user need to register to the system by inputting information to identify the user to access the system. In one embodiment, the user is an advertiser. In one embodiment, the user is a lessee.

In an embodiment, the advertiser registration module is configured to receive advertiser information via the computing device associated with the advertiser. In an embodiment, the lessee registration module is configured to receive lessee information via the computing device associated with the lessee. In an embodiment, the advertising module is configured to allow the advertiser to advertise a data comprising at least one geographical view for leasing at a monetary value, wherein the data is stored in the database. In an embodiment, the request generation module is configured to specify criteria for identifying at least one desired geographical view by the lessee. In an embodiment, the search engine module is configured to search for the at least one desired geographical view in the database relevant to the criteria specified by the lessee. In one embodiment, the search engine module is further configured to search and display at least one desired geographical view to the lessee.

In an embodiment, the leasing module is configured to allow the lessee to lease at least one displayed geographical view at the monetary value specified by the advertiser for a period. In one embodiment, the display module configured to display at least one leased geographical view from the webserver on the at least one window. In one embodiment, the at least one window comprising a display unit and a display controller. In one embodiment, the display controller in communication with the webserver configured to project the at least one leased geographical view via the display unit. In one embodiment, the tracking module implemented with a timer is configured to track the period of lease.

In an embodiment, a computer implemented method for leasing and projecting a geographical view in at least one window is disclosed. In one embodiment, the computer implemented method comprising the steps of: receiving at a webserver comprising a processor, via an advertiser registration module, an advertiser information via a computing device associated with an advertiser, at one step. In one embodiment, the advertiser information comprises contact name, address, email address and contact number. At another step, receiving at a processor, via a lessee registration module, a lessee information via a computing device associated with a lessee. In one embodiment, the lessee information comprises contact name, address, email address and contact number.

At another step, storing at a database in communication with the processor, the advertiser information and the lessee information. At another step, advertising at the processor, via an advertising module, a data comprising at least one geographical view for leasing at a monetary value, wherein the data is stored in the database. At another step, specifying criteria at the processor, via a request generation module, for identifying at least one desired geographical view by the lessee. At another step, searching at the database in communication with the processor, via a search engine module, at least one desired geographical view in the database to display the at least one desired geographical view to the lessee. At another step, leasing at the processor, via a leasing module, the at least one displayed geographical view at the monetary value specified by the advertiser for a period. At another step, displaying at the processor, via a display module, at least one leased geographical view from the webserver on at least one window.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF DRAWINGS

The foregoing summary, as well as the following detailed description of the invention, is better understood when read in conjunction with the appended drawings. For illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 is a block diagram of an environment implemented in accordance with various embodiments of the invention.

FIG. 2 is a block diagram of web server in an embodiment of the present invention.

FIG. 3 illustrates a computer implemented method for leasing and projecting a geographical view on a window in an embodiment of the present invention.

### DETAILED DESCRIPTION OF THE INVENTION

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

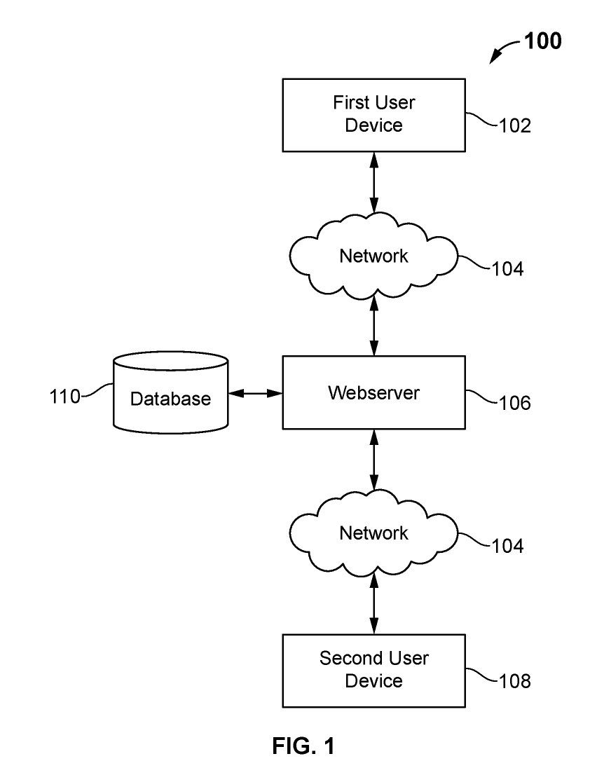

The present invention generally relates to system and method for broadcasting a geographical view. Specifically, this invention relates to a system and method for leasing and projecting a geographical view on a window via a single platform. Referring to FIG. 1, an environment 100 for leasing and projecting a geographical view on the window is disclosed, according to an embodiment of the present invention. The system comprises a first user device 102, a second user device 108, web server 106 and a database 110. The system connected to the first user device 102 and the second user device 108 via a network 104. In an embodiment, the first user device 102 is associated with an advertiser is configured to access the webserver 106. In one embodiment, the first user device 102 is at least one of a tablet computer, personnel computers, personnel digital assistants, smart phones, smart televisions, palm tops, phablets and laptops. As described herein, “advertiser” refers to the person/entity that is planning to advertise at least one geographical view for leasing at a monetary value. In an embodiment, the second user device 108 is associated with a lessee is configured to access the webserver 106 of the system. In one embodiment, the second user device 108 is at least one of a tablet computer, personnel computers, personnel digital assistants, smart phones, smart televisions, palm tops, phablets and laptops. As described herein, “lessee” refers to the person/entity is willing to lease at least one of the advertised geographical view at the specified monetary value.

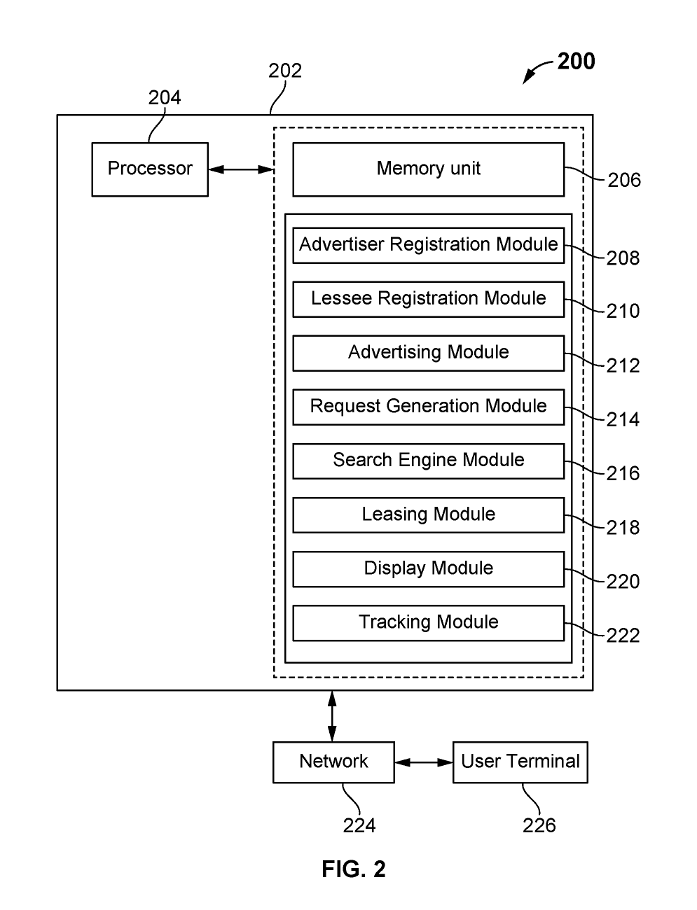

In one embodiment, the database 110 is accessible by the webserver 106. In one embodiment, the database 110 is integrated into the webserver 106, or separate from it. In one embodiment, the database 110 resides in a connected server or in a cloud computing service. In one embodiment, the database 110 comprise a memory to store and organize certain data for use by the webserver 106. In some embodiment, the database 110 stores advertiser data containing information of plurality of advertiser, lessee data containing information of plurality of lessee. In one embodiment, the database 110 stores data relating to a geographical view for lease, wherein the data comprises a monetary value of the geographical view and terms for leasing the geographical view. In one embodiment, the webserver 106 is at least one of a general or special purpose computer. In one embodiment, it operates as a single computer, which could be a hardware and/or software server, a workstation, a desktop, a laptop, a tablet, a mobile phone, a mainframe, a supercomputer, a server farm, and so forth. In one embodiment, the computer is a touchscreen and/or non-touchscreen and runs on any type of OS, such as iOS™ Windows™, Android™, Unix™, Linux™ and/or others. In one embodiment, the computer is in communication with network 104. Such communication can be via a software application, a mobile app, a browser, an OS, and/or any combination thereof. In another embodiment, the webserver 106 is detailly illustrated in FIG. 2.

FIG. 2 is a block diagram 200 of a webserver 202 in an embodiment of the present invention. The server 202 comprises a processor 204 and a memory unit 206. The memory unit 206 comprises a set of program module. The set of program module comprises an advertiser registration module 208, a lessee registration module 210, an advertising module 212, a request generation module 214, a search engine module 216, a leasing module 218, a display module 220, and a tracking module 222. In one embodiment, a user device 226 associated with a user is enabled to access server 202 via a network 224. In one embodiment, the user is an advertiser. In one embodiment, the user is a lessee. In an embodiment, the user device 226 is at least one of a tablet computer, computing device, personnel computers, personnel digital assistants, smart phones, smart televisions, palm tops, phablets and laptops. In another embodiment, the network 224 is at least anyone of a Wi-Fi network, WiMax network, and wireless local area network. The processor 204 in communication with the memory unit 206 and the database is configured to execute the set of program modules.

In an embodiment, the advertiser is configured to register with the system by inputting information to identify the advertiser. In one embodiment, the advertiser registration module 208 is configured to receive advertiser information via the computing device associated with the advertiser. In one embodiment, the system creates an advertiser record in the database and stores the advertiser information in the created record. In one embodiment, the advertiser information comprises contact name, address, email address and contact number. In one embodiment, the lessee need to register to the system by inputting information to identify the lessee. In an embodiment, the lessee registration module 210 is configured to receive lessee information via the computing device associated with the lessee. In one embodiment, the system creates a lessee record in the database and stores the lessee information in the created record. In one embodiment, the lessee information comprises contact name, address, email address and contact number.

In an embodiment, the advertising module 212 is configured to allow the advertiser to advertise a data comprising at least one geographical view for leasing at a monetary value, wherein the data is stored in the database. In one embodiment, the data provided by the advertiser is stored in the respective advertiser record of the database. As described herein, the “geographical view” refers to a view encompassing one or more of a human, political, cultural, social, and economic aspects of a human society and a natural environment of the earth. In an embodiment, the data comprises address, location, coordinates or other indications respective of the at least one geographic view. In an embodiment, the request generation module 214 is configured to specify criteria for identifying at least one desired geographical view by the lessee. In one embodiment, the specified criteria comprise a name, address or keywords relating to a geographic region.

In an embodiment, the search engine module 216 is configured to search for the at least one desired geographical view in the database. In one embodiment, the search engine module 216 is configured to search in the advertiser record in the database using the criteria specified by the lessee. In one embodiment, the search engine module 216 is configured to display at least one desired geographical view relevant to the criteria specified by the lessee. In an embodiment, the leasing module 218 is configured to allow the lessee to lease at least one displayed geographical view at the monetary value specified by the advertiser for a period.

In an embodiment, the display module 220 is configured to display at least one leased geographical view from the webserver 202 on the at least one window. In one embodiment, the at least one window comprising a display unit and a display controller. In one embodiment, the display controller in communication with the webserver 202 configured to project the at least one leased geographical view via the display unit. In one embodiment, the at least one leased geographical view is transmitted form the webserver 202 to the display controller via the network 224. In one embodiment, at least one window comprises one or more of a billboard, LED display, LCD display, video billboards, computer monitors, shopping mall kiosks, stadium displays, personal digital assistants, movie-theater screens, video projectors, and cellular phone displays. In one embodiment, the tracking module 222 implemented with a timer is configured to track the period of lease.

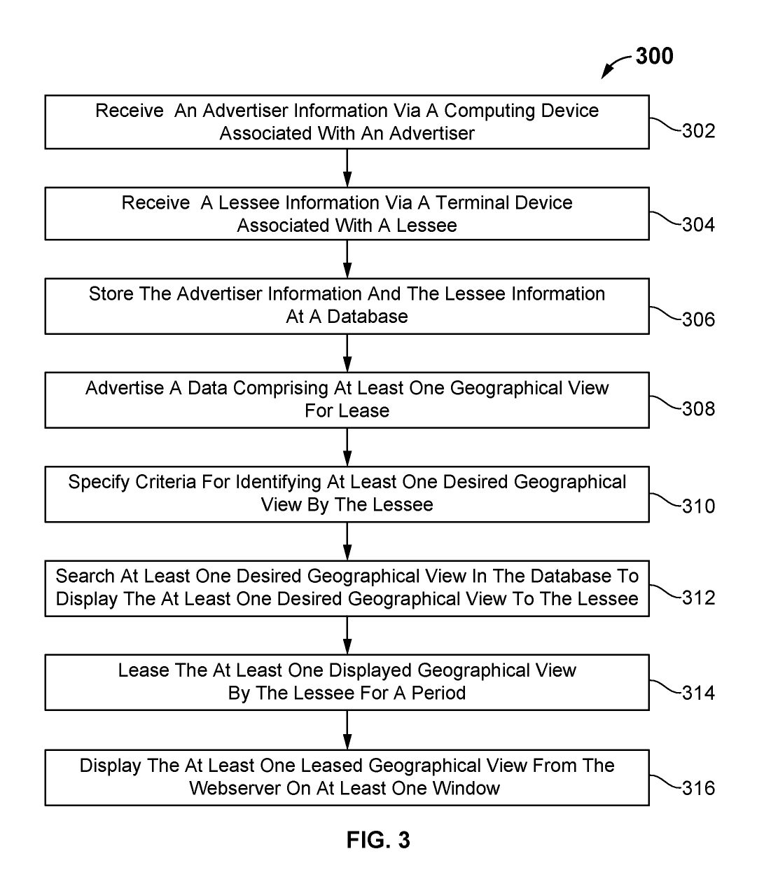

Referring to FIG. 3, a computer implemented method for leasing and projecting a geographical view in at least one window is disclosed, in an embodiment of the present invention. In another embodiment, a non-transitory program storage device readable by computer, and comprising a program of instructions executable by a processor to lease and project a geographical view in at least one window using the system is also disclosed. In one embodiment, the computer implemented method 300 comprising the steps of: receiving at a webserver comprising a processor, via an advertiser registration module, an advertiser information via a computing device associated with an advertiser, at step 302. In one embodiment, the advertiser information comprises contact name, address, email address and contact number. At step 304, receiving at a processor, via a lessee registration module, a lessee information via a terminal device associated with a lessee. In one embodiment, the lessee information comprises contact name, address, email address and contact number.

At step 306, storing at a database in communication with the processor, the advertiser information and the lessee information. At step 308, advertising at the processor, via an advertising module, a data comprising at least one geographical view for leasing at a monetary value, wherein the data is stored in the database. At step 310, specifying criteria at the processor, via a request generation module, for identifying at least one desired geographical view by the lessee. At step 312, searching at the database in communication with the processor, via a search engine module, at least one desired geographical view in the database to display the at least one desired geographical view to the lessee. At step 314, leasing at the processor, via a leasing module, the at least one displayed geographical view at the monetary value specified by the advertiser for a period. At step 316, displaying at the processor, via a display module, at least one leased geographical view from the webserver on the at least one window.

The foregoing examples have been provided merely for the purpose of explanation and are in no way to be construed as limiting of the present concept disclosed herein. While the concept has been described with reference to various embodiments, it is understood that the words, which have been used herein, are words of description and illustration, rather than words of limitation. Further, although the concept has been described herein with reference to particular means, materials, and embodiments, the concept is not intended to be limited to the particulars disclosed herein; rather, the concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the concept in its aspects.

What is claimed is:

1. A system for leasing and projecting geographical view on at least one window, comprising:
a webserver comprising at least one processor;
a memory device connected to the at least one processor;
at least one database in communication with the webserver for storing advertiser information, lessee information and data relating to a geographical view for lease, wherein the data comprises a monetary value of the geographical view for lease and terms for leasing the geographical view;
a set of program modules stored in the memory device, readable by the at least one processor, comprising:
an advertiser registration module configured to receive advertiser information via a computing device associated with an advertiser;
a lessee registration module configured to receive lessee information via a computing device associated with a lessee;
an advertising module configured to allow the advertiser to advertise a data comprising at least one geographical view for lease, wherein the data is stored in the database;
a request generation module configured to specify criteria for identifying at least one desired geographical view by the lessee;
a search engine module configured to search for the at least one desired geographical view in the database and to display at least one desired geographical view to the lessee;
a leasing module configured to allow the lessee to lease at least one displayed geographical view at the monetary value specified by the advertiser for a period; and
a display module configured to display at least one leased geographical view from the webserver on the at least one window.

2. The system of claim 1, wherein the at least one window comprising a display unit and a display controller.

3. The system of claim 1, wherein the display controller in communication with the webserver configured to project the at least one leased geographical view via the display unit.

4. The system of claim 1, wherein the at least window comprises one or more of a billboard, LCD display, LED display and a kiosk.

5. The system of claim 1, further comprising a tracking module implemented with a timer to track the period of lease.

6. The system of claim 1, wherein the computing device is at least one of tablet computers, personnel computers, personnel digital assistants, smart phones, smart televisions, palm tops, phablets and laptops.

7. The system of claim 1, wherein the computing device accesses the webserver via the network.

8. The system of claim 1, wherein the memory unit is at least one of a volatile memory, non-volatile memory, read only memory (ROM), random access memory (RAM), and a flash memory.

9. The system of claim 1, wherein the advertiser information comprises contact name, address, email address and contact number.

10. The system of claim 1, wherein the lessee information comprises contact name, address, email address and contact number.

11. A method for leasing and projecting geographical view on at least one window, comprising the steps of:
receiving at a webserver comprising a processor, via an advertiser registration module, an advertiser information via a computing device associated with an advertiser;
receiving at a processor, via a lessee registration module, a lessee information via a terminal device associated with a lessee;
storing at a database in communication with the processor, the advertiser information and the lessee information;
advertising at the processor, via an advertising module, a data comprising at least one geographical view for leasing at a monetary value by the advertiser, wherein the data is stored in the database;
specifying criteria at the processor, via a request generation module, for identifying at least one desired geographical view by the lessee;
searching at the database in communication with the processor, via a search engine module, at least one desired geographical view in the database to display the at least one desired geographical view to the lessee;
leasing at the processor, via a leasing module, the at least one displayed geographical view at the monetary value specified by the advertiser for a period;
displaying at the processor, via a display module, at least one leased geographical view from the webserver on the at least one window.

12. The method of claim 11, wherein the at least one window comprising a display unit and a display controller.

13. The method of claim 11, wherein the display controller in communication with the webserver configured to project the at least one leased geographical view via the display unit.

14. The method of claim 11, wherein the at least one window comprises one or more of a highway billboard, and a kiosk.

15. The method of claim 11, further comprising a step of: providing, at the processor via a tracking module, a clock indicating time to track the period of lease.

16. The method of claim 11, wherein the computing device is at least one of tablet computers, personnel computers, personnel digital assistants, smart phones, smart televisions, palm tops, phablets and laptops.

17. The method of claim 11, wherein the computing device accesses the webserver via the network.

18. The method of claim 11, wherein the advertiser information comprises contact name, address, email address and contact number.

19. The method of claim 11, wherein the lessee information comprises contact name, address, email address and contact number.

20. A non-transitory program storage device readable by computer, and comprising a program of instructions executable by a processor to perform a computer implemented method for leasing and projecting geographical view on at least one window, comprising the steps of:
receiving at a webserver, via an advertiser registration module, an advertiser information via a computing device associated with an advertiser;
receiving at the webserver, via a lessee registration module, a lessee information via a terminal device associated with a lessee;
storing at a database in communication with the webserver, the advertiser information and the lessee information;
advertising at the webserver, via an advertising module, a data comprising at least one geographical view for leasing at a monetary value by the advertiser, wherein the data is stored in the database;
specifying at the webserver, via a request generation module, criteria for identifying at least one desired geographical view by the lessee;
searching at the database, via a search engine module, at least one desired geographical view in the database to display the at least one desired geographical view to the lessee;
leasing at the webserver, via a leasing module, the at least one displayed geographical view at the monetary value specified by the advertiser for a period; and
displaying at the webserver, via a display module, at least one leased geographical view from the webserver on the at least one window.
